(19) United States
(12) Patent Application Publication
(10) Pub. No.: US 2016/0001396 A1
(43) Pub. Date: Jan. 7, 2016

(54) Method for Nano-Structuring Polmer Materials Using Pulsed Laser Radiation in an Inert Atmosphere

(71) Applicant: EADS DEUTSCHLAND GMBH, Ottobrunn (DE)

(72) Inventors: Erhard BRANDL, Eitensheim (DE); Ante KURTOVIC, Paderborn (DE); Tobias MERTENS, Muenchen (DE)

(21) Appl. No.: 14/434,979

(22) PCT Filed: Oct. 10, 2013
(86) PCT No.: PCT/DE2013/000583

§ 371 Date: Sep. 18, 2015

(30) Foreign Application Priority Data
Oct. 11, 2012 (DE) 10 2012 019 917.1

(51) Int. Cl. B23K 26/00; B23K 26/0622; B23K 26/12

(52) U.S. Cl. CPC B23K 26/0078; B23K 26/123; B23K 26/125; B23K 26/1224; B23K 26/0622

(57) ABSTRACT

In a method for generating a surface having a solid polymeric material, which has surface structures with dimensions in the sub-micrometer range, the untreated surface, on which the structures are to be generated and which are accessible to laser radiation, is scanned once or multiple times using a pulsed laser beam in an inert gas atmosphere in such a way that adjacent light spots of the laser beam adjoin each other in a gapless manner or overlap and a certain range of a specified relation between process parameters is observed.

### CROSS REFERENCE TO RELATED APPLICATIONS

This application is a continuation of PCT International Application No. PCT/DE2013/000583, filed Oct. 10, 2013, which claims priority under 35 U.S.C. §119 from German Patent Application No. 10 2012 019 917.1, filed Oct. 11, 2012, the entire disclosures of which are herein expressly incorporated by reference.

### FIELD OF THE INVENTION

The invention relates to a method for producing a surface on a workpiece that comprises a solid polymeric material, which workpiece has surface structures with dimensions in the sub-micrometer range.

### BACKGROUND OF THE INVENTION

The wettability with and adherence of liquid, semi-solid and solid substances on the surface of workpieces of for example ceramics, glass, plastics or carbon is to a large extent dependent on the surface condition thereof. This is of great significance in the case of the treatment with or the application and adherence of materials such as for example adhesive, varnish, solder, bone cement, sealant, adhesion promoter, layers for protecting against chemical or thermal effects or biological tissue. Degreasing and other cleaning processes such as mechanical roughening enhance the wettability and the adhesiveness to a certain extent. However, these properties are substantially enhanced even further with increasing roughness of the surface, i.e. with a larger and more structured surface and as a result an enhanced chemical/mechanical anchoring of materials to be applied thereto.

EP 0 914 395B1, which is included herein by reference, describes a method for treating an uncleaned metal surface that comprises the treatment of the surface using an organosilane and the exposure of the surface to a laser.

From US 2010/0143744 A1, a method for producing a surface of a workpiece is known, wherein surface structures with dimensions in the micrometre range are produced. The described embodiment examples relate to surfaces with semiconductors or metals, wherein for a surface treatment of amorphous silicon and a surface treatment of titanium or stainless steel, laser parameters are specified, in which laser pulses in the femtosecond range are used. It is also explained that the method will probably also work for polymers, however no parameters for the surface treatment are indicated. For the embodiment examples described, different atmospheric environments including vacuum, air as well as chemically reactive materials such as HCl or SF6 are examined.

From U.S. Pat. No. 6,120,725, a method for forming a complex profile of uneven indentations in the surface of an ablative workpiece by way of laser ablation is described. The laser ablation is carried out in such a way that indentations in the micrometre range are generated. By way of superimposing masks or splitting the laser beam and by superimposing multiple introductions of corresponding indentations, structures with distances in the sub-micrometre range are to be generated. As a workpiece material, specific polymers are mentioned.

Both documents mentioned above deal with surface treatments for optical purposes.

One aim of the invention is to develop a simple method, if possible without the need for the use of chemicals, for achieving good roughness on solid polymeric surfaces.

### SUMMARY OF THE INVENTION

The invention relates to a method for producing a surface of a workpiece, wherein surface structures with dimensions in the sub-micrometer range are generated, wherein the surface comprises at least one solid polymeric material, wherein an initial surface comprising the material, which surface does not yet have the surface structures with dimensions in the sub-micrometer range and which is accessible to radiation using a laser beam and on which the surface structures are to be generated, is completely scanned with a pulsed laser beam once or multiple times in such a way that adjacent laser scanning spots adjoin each other in a gapless manner or overlap, wherein the wavelength of the laser λ is approx. 100≦λ≦approx. 11,000 nm and the following conditions are met:

approx. 0.5≦ε≦approx. 1350

with

$$ɛ = \frac{{P}_{P} \cdot \sqrt{{P}_{m}} \cdot f \cdot α \cdot \sqrt{t} \cdot \sqrt{κ}}{{d}^{2} \cdot \sqrt{v} \cdot \sqrt{{c}_{P}}} \cdot {10}^{4} \qquad ( equation 1 )$$

wherein:
Pₚ: pulse peak power of the exiting laser radiation [kW]
Pₘ: average power of the exiting laser radiation [W]
f: repetition rate of the laser pulse [kHz]
α: absorption of the laser radiation of the irradiated material [%] under normal conditions
t: pulse length of the laser pulses [ns], wherein t≧approx. 0.1 ns
κ: specific thermal conductivity [W/mK] under normal conditions and averaged over the various dimensions in space
d: diameter of the laser beam on the workpiece [μm]
v: scanning rate on the workpiece surface [mm/s]
cₚ: specific thermal capacity [J/kgK] under normal conditions
wherein the atmosphere, in which the method is carried out, is vacuum or a gas or gas mixture that is inert in relation to the surface under the process conditions.

Further, a workpiece is described that comprises a surface comprising at least one solid polymeric material, wherein the surface has a structure that can be generated using the above method.

Finally, the use of the above-mentioned workpiece or with a surface generated using the above-mentioned method during the assembly or coating of the workpiece with a like or different material or with or without an adhesive is described.

### BRIEF DESCRIPTION OF THE DRAWINGS

FIGS. 1A and 1B each show a top view of an untreated surface of polyether ether ketone (PEEK);

FIGS. 2A and 2B each show a top view of a nano-pored PEEK surface layer with a high adhesive strength formed on the substrate;

FIGS. 3A and 3B each show modifications to the PEEK surface layer;

FIGS. 4A and 4B each show a top surface of a nano-pored PEEK surface layer with a high adhesive strength formed on the substrate;

FIGS. 5A and 5B each show an untreated surface of epoxy resin;

FIGS. 6A and 6B each show a nano-pored epoxy resin surface layer with a high adhesion strength formed on the substrate;

FIGS. 7A and 7B show modifications to the epoxy surface layer;

FIGS. 8A and 8B show modifications to the epoxy surface layer;

FIGS. 9A and 9B each show an untreated surface of polyurethane;

FIGS. 10A and 10B each show a top view of a nano-pored polyurethane surface layer with a high adhesion strength formed on the substrate;

FIGS. 11A and 11B show modifications to the polyurethane surface layer; and

FIGS. 12A and 12B each show a top view of a nano-pored polyurethane surface layer with a high adhesion strength formed on the substrate.

### DETAILED DESCRIPTION OF THE DRAWINGS

As mentioned in the beginning, the roughening or structuring in the sub-micrometer range of surfaces is essential for achieving good adhesion of adhesives, varnishes, biological tissue and other coatings such as thermal protective coatings and metallic adhesion promoting layers.

It has now surprisingly been found that by radiating just once or multiple times using a pulsed laser beam under the conditions mentioned in the method described above, sub-microstructured (or nanostructured) surfaces with solid polymeric materials can be generated, which assure an excellent adhesion of e.g. adhesives, varnishes, solder, sealants, bone cement, adhesion promoters or biological tissue, and of coatings such as coatings for protecting from chemical or thermal effects.

If two workpieces having a surface as described above or such a workpiece with a different material are joined together under pressure, the adhesion of these joined materials can also be enhanced if nanostructures according to the invention have previously been generated on at least one side.

The surfaces generated according to the invention and provided with surface structures may in general have, depending on the embodiment, open-pored, rugged and/or fractal-like structures, such as open-pored peak and valley structures, open-pored undercut structures and cauliflower- or bulb-like structures. At least approx. 80%, preferably at least approx. 90%, even more preferably at least approx. 95% of the elevations have a size of <1 μm, which varies for example in a range of approx. 10 nm to approx. 200 nm. At least approx. 80%, preferably at least approx. 90%, even more preferably at least approx. 95% of the interspaces also have widths of less than approx. 1 μm, e.g. approx. 10 nm to approx. 50 nm. The length of the “valleys” in the case of peak-and-valley structures, however, is frequently more than approx. 1 μm.

As a rule, such nanostructures cover at least approx. 90% of the polymer surface calculated as a plane, preferably at least approx. 95%. In the case of optimally matched process parameters (in particular repetition rate, scan rate and focus diameter), the nanostructure may cover even as much as 100% of the polymer surface calculated as a plane. In the case of composite materials containing an inorganic or polymeric matrix and polymeric fibers present on the surface, or in the case of green preforms that contain a polymeric matrix and polymeric fibers present on the surface, it may be advantageous to structure the matrix and the fibers separately or to structure only the matrix or only the fibers. In this case, the above-mentioned polymer surface may relate to the surface of only the matrix or only the fibers.

The scanning of the initial surface with the laser beam may be carried out once or multiple times in succession using the same process parameters and the same laser beam or using different process parameters and the same laser beam or using different laser beams and the same process parameters or using different process parameters. By applying multiple scans it may be possible to generate even finer structures.

It should also be mentioned that naturally only such surface areas can be treated that can be reached by a laser beam. Any areas which are completely “in the shadow” (e.g. undercut geometries) cannot be structured in the manner described herein.

Usually, the initial surface, which comprises at least one solid polymeric material (referred to herein below at times as the surface material according to the invention), is not pretreated or cleaned prior to being scanned with the laser beam, although this would be possible; e.g. the surface can be cleaned using a solvent. In general, contrary to what is described in EP 0 914 395 B1, it will not be treated prior to scanning with an adhesion promoter such as for example a silane adhesion promoter, a titanate such as titanium tetraisopropylate or titanium acetylacetonate, a zirconate such as zirconium tetrabutylate, a zirconium aluminate, a thiazole, a triazole such as 1H-Benzotriazole, a phosphonate or a sulfonate, for enhancing the adhesive strength on a material to be bonded or to be applied to the surface. Even after the scanning, in general no adhesion promoter for enhancing the adhesive strength is applied before the surface is bonded with another surface, and/or a coating such as an adhesive, varnish, solder, bone cement, sealant or biological tissue and/or another coating which may for example be a protective coating, a dirt-repellent coating or an anti-adhesive coating, a coating for protecting it from chemical or thermal effects or any other functional coating, is allowed to adhere and/or is applied.

The solid polymeric material, which from that the surface is comprised, may be any solid organic polymer and mixtures thereof.

Organic polymers are usually classified into thermoplasts, elastomers, thermoplastic elastomers and thermosetting plastics.

At the temperature of use, thermoplasts are soft or hard polymeric materials which above the temperature of use have a flow transition area. They include all plastics substantially consisting of linear or thermolabile cross-linked polymer molecules. Examples include polyolefins such as polyethylene and polypropylene, polyester, polyetheretherketones, polyacetales, polycarbonates, polystyrenes, thermoplastic polyurethanes and thermoplastic ionomers as well as copolymers of the monomer units at the basis of these compounds, such as block copolymers of styrene and polyolefins.

Elastomers are polymers with a rubber-elastic behavior which at room temperature can repeatedly be stretched to at least twice their length and return, as soon as the force required for the elongation thereof is removed, immediately back to approximately their initial length. Elastomers are high-polymer materials which are cross-linked in a wide-meshed manner up to their decomposition temperature, have a steel-elastic behavior at low temperatures and do not flow in a viscous manner even at high temperatures, but are rubber-elastic at 20° C. or below up to their decomposition temperature. In general, the irreversibly cross-linked elastomers are produced by vulcanising or cross-linking natural and synthetic rubbers (which are non-cross-linked rubber-elastic polymers). The large number of rubbers, from which elastomers are produced by cross-linking, include for example, to mention but a few, acrylate rubber, polyester urethane rubber, polyether urethane rubber, peroxidically cross-linked ethylene-propylene copolymer, styrene butadiene rubber, polybutadiene, epichlorohydrin and ethylene vinyl acetate copolymer.

In an ideal case, thermoplastic elastomers (TPE) combine a number of the properties of use of elastomers and the processing properties of thermoplasts. This can be achieved if soft and elastic segments with high elongation properties and a low glass transition temperature as well as hard, crystallisable segments with low elongation, a high glass transition temperature and a propensity to associate formation (cross-linking) are present in the corresponding plastics at the same time. Thermoelastic elastomers include e.g. styrene butadiene (or isoprene or ethylene butylene) block copolymers, elastomeric alloys, polyurethane, polyether esters and polyether amides.

Thermosetting plastics are plastics produced from curable resins. They are high-polymer materials that are cross-linked in a close-meshed manner up to their decomposition temperature, are steel-elastic at lower temperatures and do not flow in a viscous manner even at high temperatures but have an elastic behavior beginning from 50° C. upwards and at the decomposition temperature with very limited deformability. Thermosetting plastics include epoxy resins, diallyl phthalate resins, urea formaldehyde resins, phenol formaldehyde resins, melamine formaldehyde resins, polyacrylates and unsaturated polyester resins.

The entire polymeric surface and also the matrices of composite materials may be made up from these materials.

Examples of polymers for the production of polymeric organic fibers or synthetic fibers that may be integrated into composite materials, are elastane, polytetrafluorethylene, polyacrylic, modacrylic, polyamide, aramide, polyvinyl chloride, polyvinylidene chloride, polyester, polyethylene, polypropylene and polyvinyl alcohol. The fibers may be, depending on demand, short, long or endless fibers.

Further, the solid polymeric material may also be inorganic-organic polymers. Examples include polysilanes, polycarbosilanes (e.g. allyl hydridopolycarbosilane), polysilazanes and polysiloxanes. Inorganic-organic polymers may be used to produce ceramic green preforms. Further, they may be used as polymer precursors for ceramic fibers. After firing, SiC, C and SiO₂ ceramic materials are formed as crystalline ceramic materials from polysilanes and polycarbosilanes, SiC and Si₃N₄ ceramic materials are formed from polysilazanes and SiC, C and SiO₂ ceramics are formed from polysiloxanes. Also amorphous ceramics with Si—C—O, Si—N—C and Si—O—C bonds may be produced by firing from these green preforms and fiber precursors containing inorganic-organic polymers.

The above-mentioned inorganic-organic polymers containing green preforms for ceramics and for fibers and/or carbon and/or boron nitride containing composite materials with a ceramic, plastic and/or carbon matrix may be provided with a surface structure as produced according to the invention.

As the composite materials mentioned, in particular the green preforms may be used for laser radiation according to the invention, which are produced using polymer infiltration technology (see for example W. D. Vogel et al, Cost effective production techniques for continuous fiber reinforced ceramic matrix composites, Ceramic Processing Science and Technology, 51, 1995, p. 225-259, and A. Mühlratzer, Entwicklung zur kosteneffizienten Herstellung von Faserverbundwerkstoffen mit keramischer Matrix, Proceedings Verbundwerkstoffe Wiesbaden, 1990, p. 22.1-22.39, which are both completely integrated here by reference). In this method, pyrolysable polymer precursors for the matrix, which are infiltrated into the fibers or fiber precursors, are cross-linked at moderate temperatures of e.g. 100-300° C. and pressures in a range of for example 10-20 bar, so that a solid composite of a cross-linked polymer and fibers or fiber precursors is obtained. This may then be irradiated using a laser, as a result of which nanostructures are formed on the surface. During the generation of the nanostructure by the effect of the laser beam, the green precursor is hardened even further on the surface and may also be chemically modified, even if work is carried out in an inert atmosphere. In this condition, the surface of the green preform will then be further treated as described below, e.g. coated with an adhesive and joined onto another surface. Only after that will the pyrolysis of the precursor material to form a ceramic be carried out.

The atmosphere in which work is carried out is a vacuum or a gas or gas mixture that is inert in relation to the surface under the process conditions, such as a noble gas, e.g. argon, helium or neon, or in many cases also nitrogen, air or CO₂, or a mixture thereof, wherein the pressure is generally in a range of approx. 10⁻¹⁷ bar up to approx. 10⁻⁴ bar, if work is carried out in a vacuum without adding a specific gas, or of approx. 10⁻⁶ bar up to approx. 15 bar, if work is carried out in an atmosphere of an especially added gas or gas mixture and the temperature outside of the laser beam is in a range from approx. −50° C. to approx. 350° C. This means that the atmosphere can be selected such that it is inert in particular in relation to the surface material according to the invention under the working conditions of pressure and temperature, which means that it will not enter into a reaction with the surface material. This may in many cases for example be the ambient atmosphere at ambient pressure and temperature, which is preferred if the particular surface allows this. A person skilled in the art will know under which conditions a certain surface material is inert and/or can find out by way of a suitable analysis process such as X-Ray Photoelectron Spectroscopy (XPS), EDX (Energy Dispersive X-Ray Analysis), FTIR Spectroscopy, Time of Flight Secondary Ion Mass Spectrometry (TOF-SIMS), EELS (Electron Energy Loss Spectroscopy), HAADF (High Angle Annular Dark Field) or NIR (Near Infrared Spectroscopy).

The values of E, which must result from the parameters of the equation indicated above, in order to ensure that the surface structuring targeted according to the invention is achieved, are in the order of approx. 0.5≦ε≦approx. 1350, preferably approx. 0.6≦ε≦approx. 1300, more preferably approx. 0.7≦ε≦approx. 1250.

The laser wavelength λ is from approx. 100 nm to approx. 11,000 nm. Lasers that can be used are pulsed solid-state lasers such as e.g. Nd:YAG (λ=1064 nm or 533 nm or 266 nm), Nd:YVO₄ (λ=1064 nm), diode lasers with e.g. λ=808 nm, gas lasers such as e.g. excimer lasers, with e.g. KrF (λ=248 nm) or H₂ (λ=123 nm or 116 nm) or a CO₂ laser (10,600 nm).

As noted above, the pressure present in the method according to the invention is generally, depending on whether processing is carried out in a vacuum or in an inert atmosphere, in a range from approx. 10⁻¹⁷ bar to approx. 5 bar, and the temperature is generally in a range from −50° C. to approx. 100° C.

The specific thermal capacity cₚ under normal conditions and the specific thermal conductivity κ, averaged in the various dimensions in space, under normal conditions of the material according to the invention, which are to be fitted into the above-mentioned expression for κ, are material properties of the irradiated material according to the invention.

The absorption of the radiation a under normal conditions is a function of the wavelength. As a result of this property of the absorption, the wavelength α of the laser radiation is indirectly integrated into the above equation. The absorption of the radiation at a certain wavelength can be determined using spectroscopical methods as known to a person skilled in the art. They are also a material property of the irradiated material according to the invention.

Preferred parameters of the method of the invention will be indicated below. It has to be emphasised that all the parameters can be varied independently from each other.

The pulse length of the laser pulses t preferably is from approx. 0.1 ns to approx. 900 ns, more preferably from approx. 0.1 ns to approx. 600 ns.

The pulse peak power of the exiting laser radiation Pₚ preferably is from approx. 1 kW to approx. 1300 kW, more preferably from approx. 3 kW to approx. 650 kW.

The average power of the exiting laser radiation Pₘ preferably is from approx. 0.2 W to approx. 28,000 W, more preferably from approx. 1 W to approx. 8000 W.

The repetition rate of the laser pulses f preferably is from approx. 1 kHz to approx. 3000 kHz, more preferably from approx. 5 kHz to approx. 950 kHz.

The scanning rate on the workpiece surface v preferably is from approx. 30 mm/s to approx. 8000 mm/s, more preferably from approx. 200 mm/s to approx. 7000 mm/s.

The diameter of the laser beam on the workpiece d preferably is from approx. 20 μm to approx. 4500 μm, more preferably from approx. 50 μm to approx. 3500 μm.

Without wishing to be bound by theory, it is believed that the physical mechanism could be as follows: in the area according to the invention, part of the substrate changes, as a result of the impingement on the high-energy radiation on the substrate surface, into a steam and/or plasma phase. In the course of this, any possible accompanying elements of the substrate (e.g. contaminations) are also transferred into the steam and/or plasma phase. Another part of the substrate is heated and may clearly reduce in viscosity (preferably the molten phase). The steam or plasma phase condensates and/or solidifies as a result of a homogeneous nucleation in the atmosphere (in particular as a result of coagulation and coalescence processes) or heterogeneous nucleation on the substrate surface to form liquid and/or solid nanoparticles. The nanoparticles precipitating on the hot substrate surface that may have a low viscosity are, as a result of the subsequent cooling of the substrate surface, which takes place at a lower rate than the precipitation of the nanoparticles, firmly bonded to the substrate surface. In the course of this, although work is carried out in an inert atmosphere, depending on the particular polymer, a more or less pronounced carbonisation may take place on the surface as a result of the heat of the laser beam. An open-pored, rugged surface with dimensions in the sub-micrometer range is formed.

The surfaces generated according to the invention, which have the above-described nanostructures, ensure an excellent adhesion of adhesives, varnishes and other coatings. If nanostructures have been generated according to the invention on at least one workpiece with a surface comprising surface material according to the invention, then two such workpieces or one such workpiece can be bonded onto a surface from a different material by merely bonding them together under elevated pressure at room temperature or at elevated temperatures with satisfactory adhesion between them.

However, the nanostructuring of the surfaces according to the invention may also be carried out for other purposes than for enhancing adhesion. In general, it can be used to achieve modifications to the physical and/or chemical interaction of the surface with light or matter. For example, the nanostructuring may be accompanied by a change of the color or the emissivity or the electric conductivity of the surface. Also phenomena such as an increase of the number of points on which crystal nuclei or bubble nuclei may form can be utilised. One everyday example would be disposable champagne glasses from PET with a nanostructured surface as are in widespread use, which leads to an improved bubbling behavior of the beverage.

One example of particularly preferred workpieces with a surface produced according to the invention are prostheses made from ceramics or ceramic composites and implants made from ceramics or ceramic composites, the nanostructured surfaces of which ensure that the biological materials adhere excellently to the surfaces in the body, with which they are to grow together.

Described herein is the use of a workpiece with a surface produced according to the invention, with or without chemical modification during the coating of the workpiece, with a like or different material, with or without an adhesive. The coating may be any suitable coating for a surface material treated according to the invention, and it may be applied by any suitable means. Selected examples to be mentioned are solders, coatings applied by thermal and non-thermal spraying, coatings applied using wet chemistry or gas phase (e.g. PVD), coatings with glass-like materials, ceramics and organic materials, including biological materials or biological tissue, which are, if needed, generated directly on the surface produced according to the invention.

Prior to the firing, the surface of green preforms may, if necessary, be provided with adhesives, varnishes or other coatings, and/or it is bonded to the surface of a second workpiece. Subsequently, the firing process is carried out. This may for example be of advantage compared to bonding of fired ceramics with a coating or a second workpiece if this results in reduced stresses on the interface or to enhanced strength.

The following examples explain the invention without limiting it.

### EXAMPLES

Examples 1 to 3 illustrate the generation of surface structures according to the invention (with comparative examples) respectively in the case of a thermoplast (PEEK), a thermosetting plastic (epoxy resin) and a thermoplastic elastomer (polyurethane).

### Example 1

### Surface Structuring of Polyetheretherketone

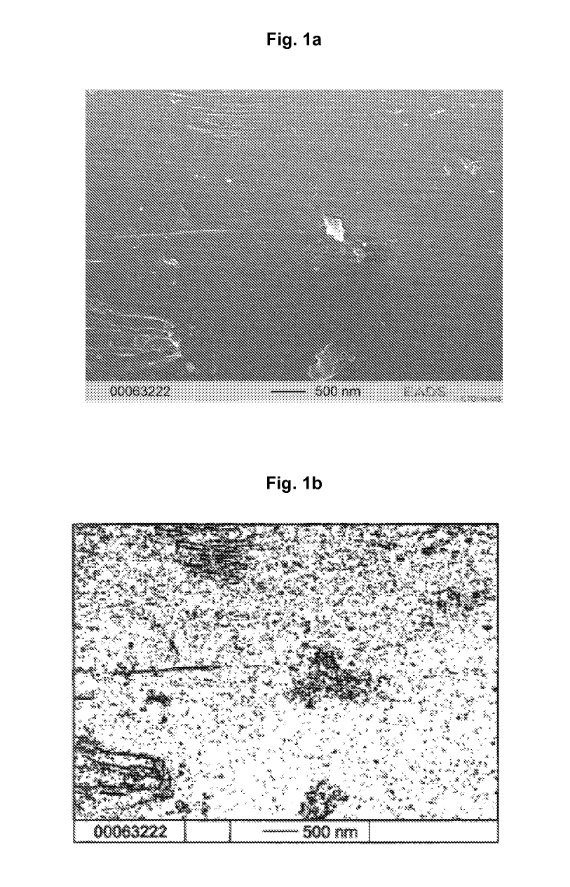

FIGS. 1a, 1b each show a top view of an untreated surface of polyetheretherketone (PEEK), a thermoplast.

Such surfaces are scanned, without any pretreatment, using pulsed laser radiation under the following test conditions.

### Test Conditions A

The surface was scanned twice in an inert argon atmosphere at ambient pressure and temperature with a pulsed laser (λ=532 nm):

The process parameters and material constants were as follows:
Pₚ: 27 kW; Pₘ: 33 W; f: 15 kHz; α: 45%; t: 82 ns; κ: 0.25 W/mK; d: 100 μm; v: 500 mm/s; cₚ: 3000 J/kgK.

The value of ε=387 as calculated according to equation 1 falls into the range according to the invention.

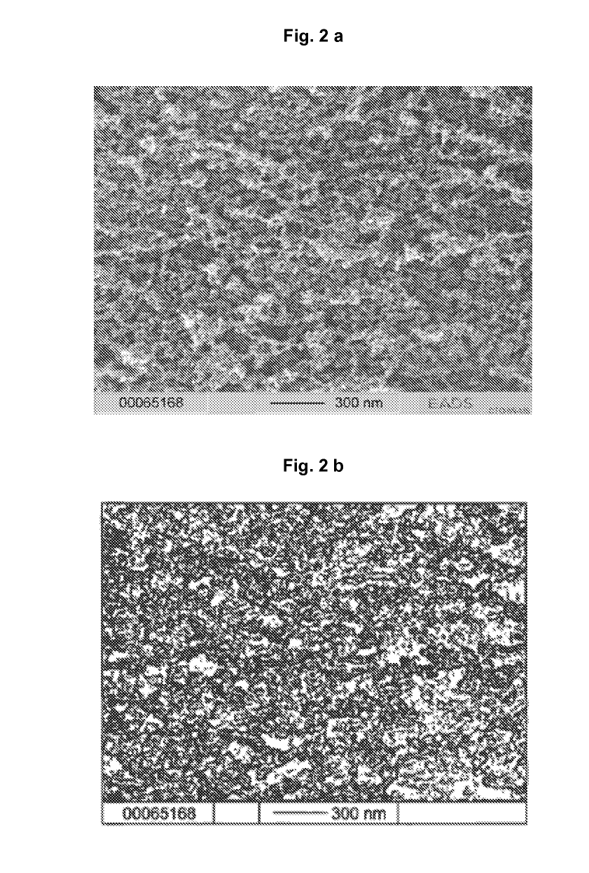

As shown in the top view in the REM image of FIGS. 2a and 2b, a nano-pored PEEK surface layer with a high adhesion strength on the substrate is formed.

### Test Conditions B

The surface was scanned twice in an inert argon atmosphere at ambient pressure and temperature with a pulsed laser (λ=1064 nm):

The method parameters and material constants were as follows:
Pₚ: 10 kW; Pₘ: 3 W; f: 20 kHz; α: 45%; t: 15 ns; κ: 0.25 W/mK; d: 500 μm; v: 3000 mm/s; cₚ: 3000 J/kgK.

The value of ε=0.40 as calculated according to equation 1 falls outside the range according to the invention.

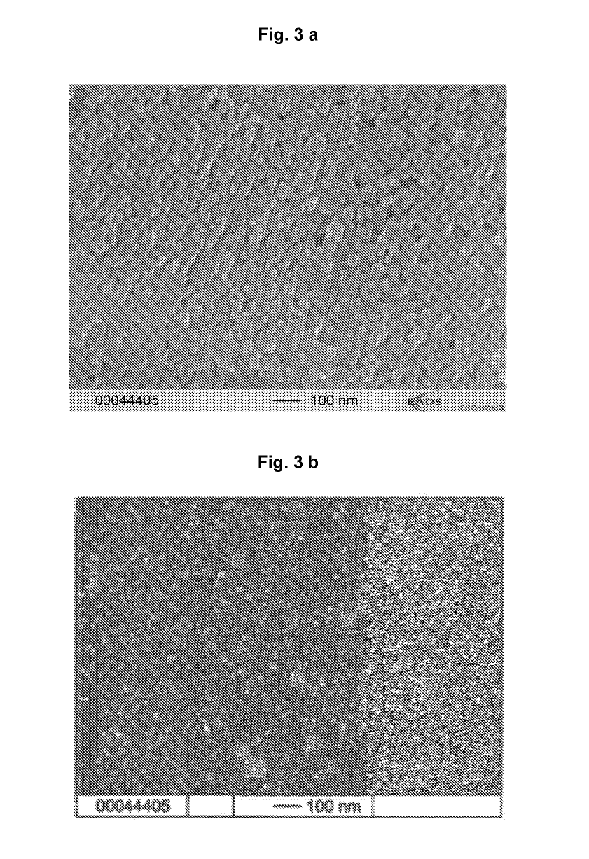

The REM image in FIGS. 3a and 3b shows modifications to the PEEK surface layer, however no formation of an extremely open-pored surface layer on a nanometre scale.

### Test Conditions C

The surface was scanned once in an inert argon atmosphere at ambient pressure and temperature with a pulsed laser (λ=1064 nm):

The process parameters and material constants were as follows:
Pₚ: 50 kW; Pₘ: 150 W; f: 20 kHz; α: 45%; t: 150 ns; κ: 0.25 W/mK; d: 350 μm; v: 20 mm/s; cₚ: 3000 J/kgK.

The value of ε=1124 as calculated according to equation 1 falls into the range according to the invention.

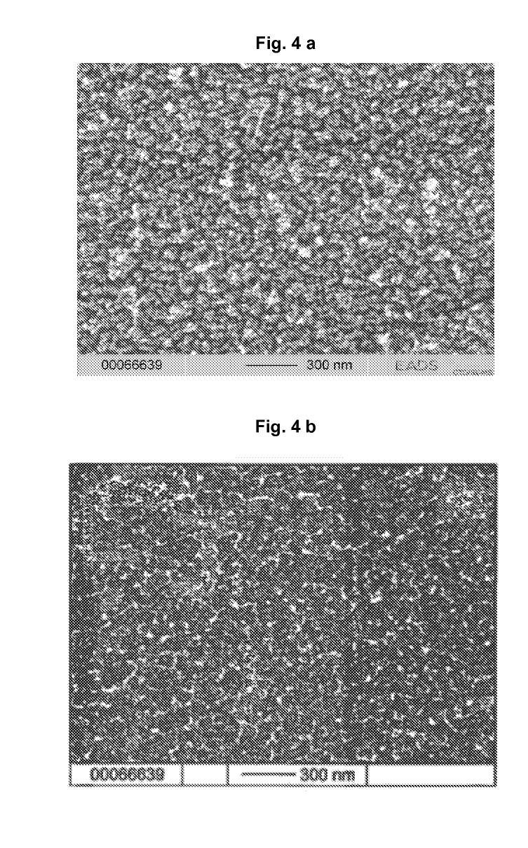

As shown in the REM image in FIGS. 4a and 4b, a nano-pored PEEK surface layer with a high adhesion strength on the substrate is formed.

### Example 2

### Surface Structuring of Epoxy Resin

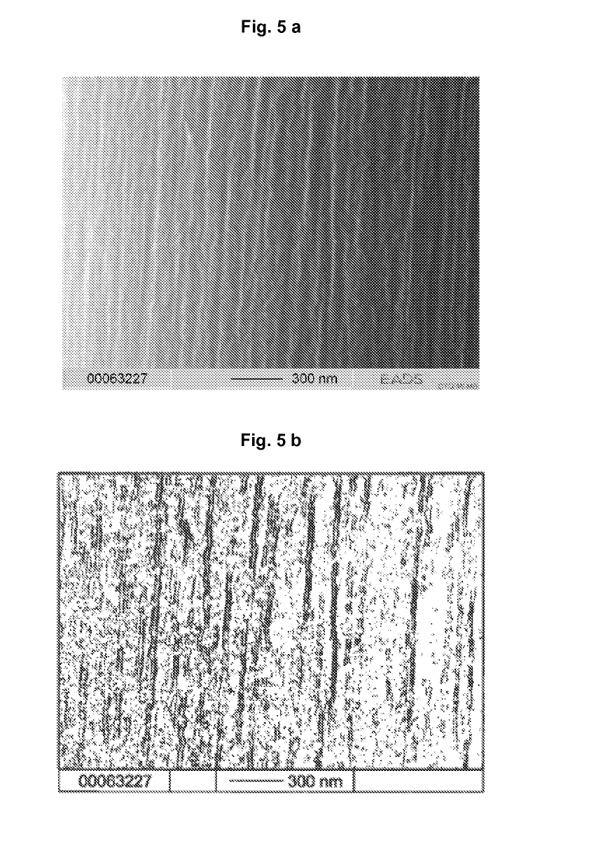

FIGS. 5a and 5b each show an untreated surface of epoxy resin, a thermosetting plastic.

Such surfaces were scanned, without any pretreatment, using pulsed laser radiation under the following test conditions.

### Test Conditions A

The surface was scanned three times in an inert argon atmosphere at ambient pressure and temperature using a pulsed laser (λ=532 nm):

The process parameters and material constants were as follows:
Pₚ: 27 kW; Pₘ: 33 W; f: 15 kHz; α: 35%; t: 82 ns; κ: 0.19 W/mK; d: 100 μm; v: 500 mm/s; cₚ: 1500 J/kgK.

The value of ε=371 as calculated according to equation 1 falls into the range according to the invention.

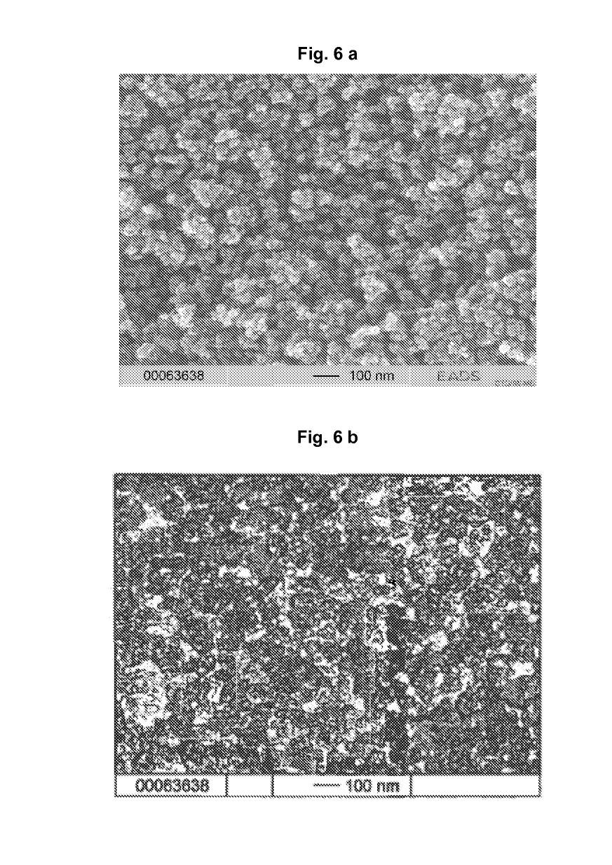

As shown in the REM image in FIGS. 6a and 6b, a nano-pored epoxy resin surface layer with a high adhesion strength on the substrate is formed.

### Test Conditions B

The surface was scanned once in an inert argon atmosphere at ambient pressure and temperature using a pulsed laser (λ=1064 nm):

The process parameters and material constants were as follows:
Pₚ: 10 kW; Pₘ: 3 W; f: 20 kHz; α: 35%; t: 15 ns; α: 0.19 W/mK; d: 500 μm; v: 3000 mm/s; cₚ: 1500 J/kgK.

The value of ε=0.39 as calculated according to equation 1 falls outside the range according to the invention.

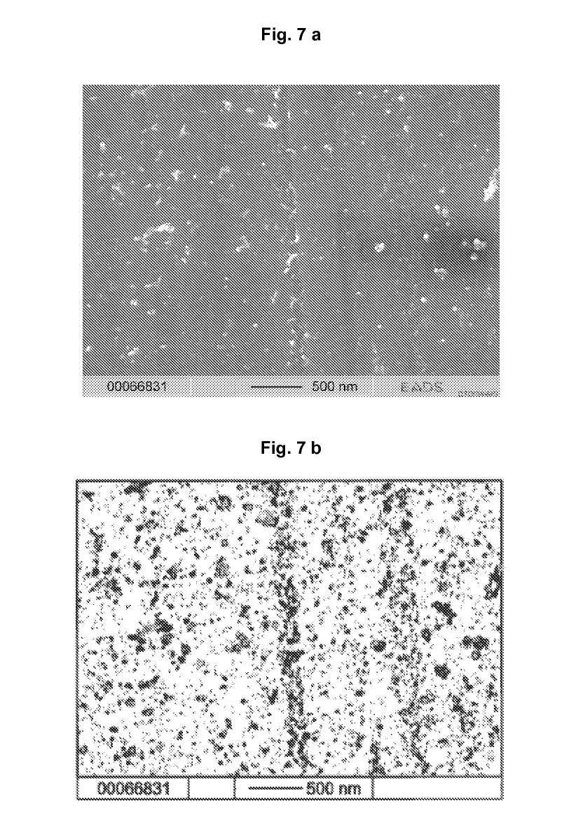

The REM image in FIGS. 7a and 7b shows modifications to the epoxy surface layer, however no formation of an extremely open-pored surface layer on a nanometre scale.

### Test Conditions C

The surface was scanned once in an inert argon atmosphere at ambient pressure and temperature using a pulsed laser (λ=1064 nm):

The process parameters and material constants were as follows:
Pₚ: 50 kW; Pₘ: 150 W; f: 20 kHz; α: 35%; t: 150 ns; κ: 0.19 W/mK; d: 350 μm; v: 10 mm/s; cₚ: 1500 J/kgK.

The value of ε=1525 as calculated according to equation 1 falls outside the range according to the invention.

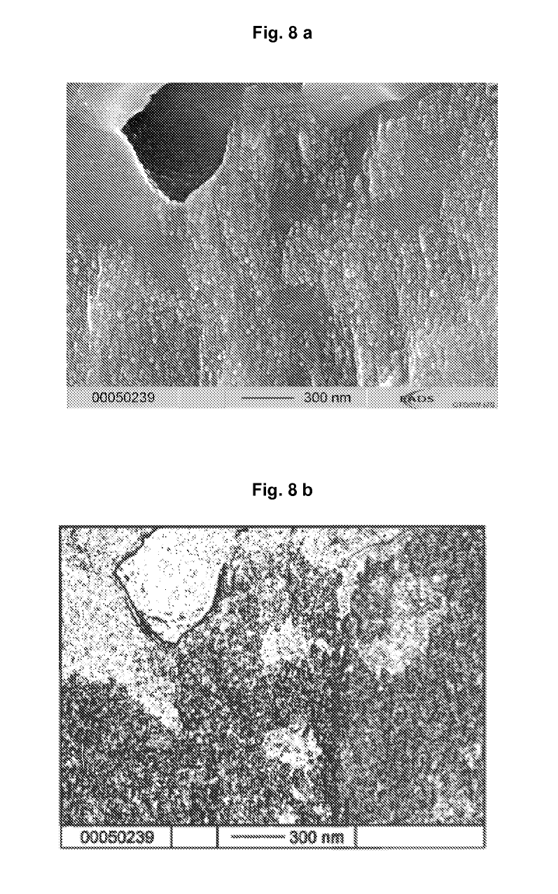

The REM image of FIGS. 8 and 8b shows modifications to the epoxy surface layer, however no formation of an extremely open-pored surface layer on a nanometre scale.

### Example 3

### Surface Structuring of Polyurethane

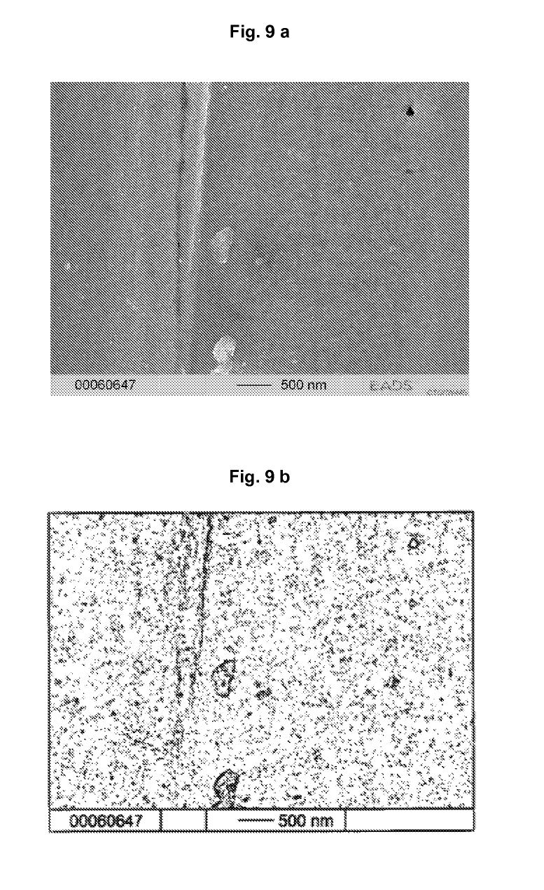

FIGS. 9a and 9b each show an untreated surface of polyurethane, a thermoplastic elastomer.

Such surfaces were scanned, without any pretreatment, using pulsed laser radiation under the following test conditions.

### Test Conditions A

The surface was scanned once under vacuum (10⁻² mbar) using a pulsed laser (λ=1064 nm):

The process parameters and material constants were as follows:
Pₚ: 10 kW; Pₘ: 3 W; f: 20 kHz; α: 45%; t: 15 ns; κ: 0.29 W/mK; d: 500 μm; v: 3000 mm/s; cₚ: 1700 J/kgK.

The value of ε=0.58 as calculated according to equation 1 falls into the range according to the invention.

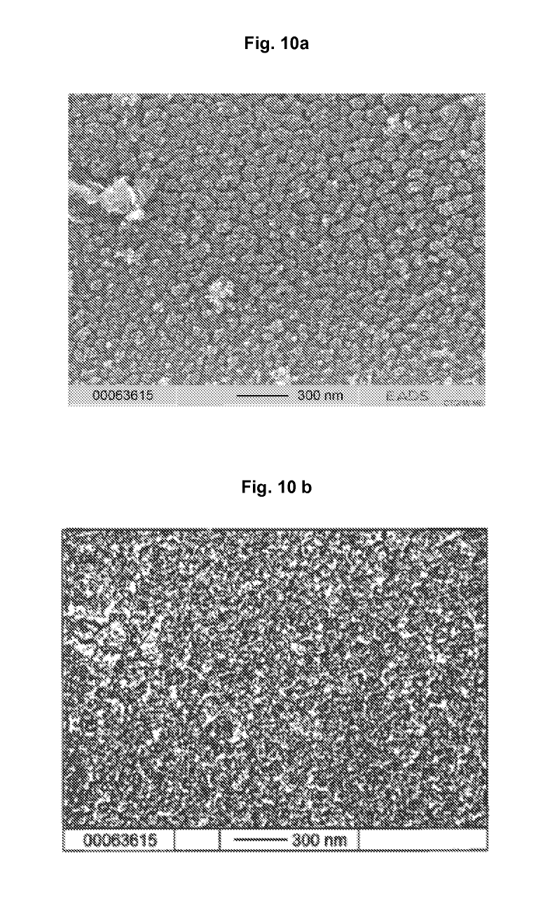

As shown in the REM image of FIGS. 10a and 10b, a nano-pored polyurethane surface layer with a high adhesion strength on the substrate is formed.

### Test Conditions B

The surface was scanned once in an inert argon atmosphere at ambient pressure and temperature using a pulsed laser (λ=1064 nm):

The process parameters and material constants were as follows:
Pₚ: 50 kW; Pₘ: 150 W; f: 20 kHz; α: 45%; t: 150 ns; κ: 0.29 W/mK; d: 350 μm; v: 10 mm/s; cₚ: 1700 J/kgK.

The value of ε=2275 as calculated according to equation 1 falls outside the range according to the invention.

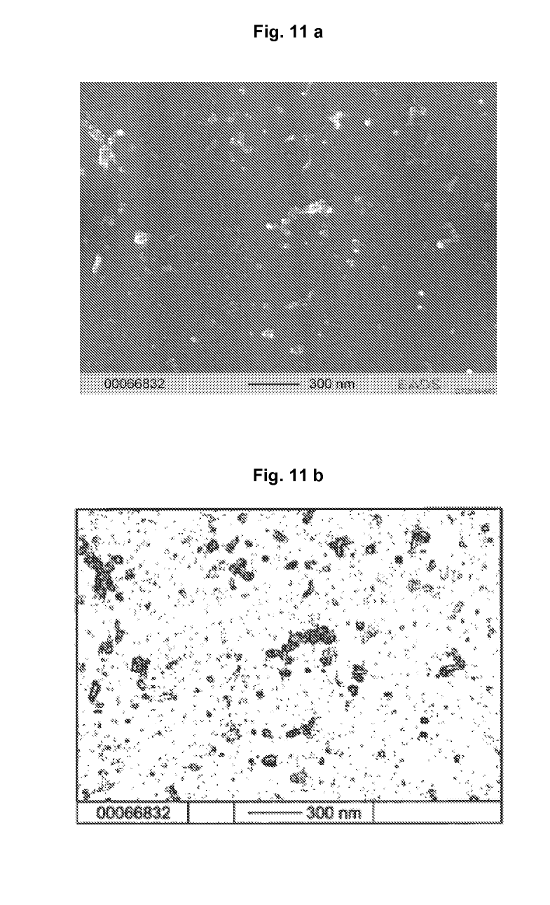

The REM image of FIGS. 11a and 11b shows modifications to the polyurethane surface layer, however no formation of an extremely open-pored surface layer on a nanometre scale.

### Test Conditions C

The surface was scanned once in a vacuum (10⁻² mbar) using a pulsed laser (λ=1064 nm):

The process parameters and material constants were as follows:
Pₚ: 50 kW; Pₘ: 105 W; f: 14 kHz; α: 45%; t: 150 ns; κ: 0.29 W/mK; d: 350 μm; v: 10 mm/s; cₚ: 1700 J/kgK.

The value of ε=1332 as calculated according to equation 1 falls into the range according to the invention.

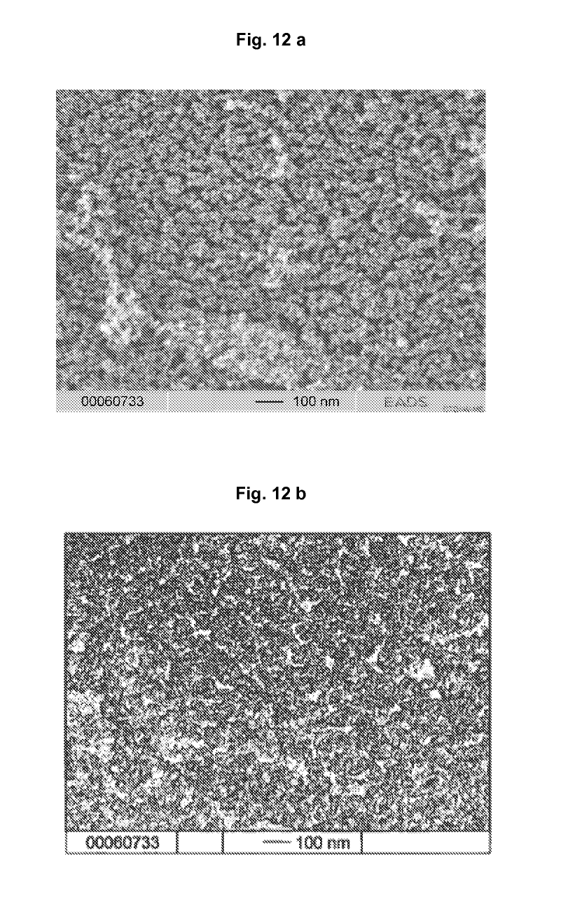

As shown in the REM image on FIGS. 12a and 12b, a nano-pored polyurethane surface layer with a high adhesion strength on the substrate is formed.

1-9. (canceled)

10. A method for generating a surface of a workpiece, the method comprising the acts of:
generating surface structures having dimensions in the sub-micrometer range, wherein the surface comprises at least one solid polymeric material, by: completely scanning once or multiple times an initial surface comprising the material, which initial surface does not yet have the surface structures with dimensions in the sub-micrometer range and which is accessible to radiation using a laser beam and on which the surface structures are to be generated, using a pulsed laser beam such that adjacent laser scanning spots adjoin each other in a gapless manner or overlap, wherein
the wavelength of the laser λ is 100≦λ≦11,000 nm and the following conditions are met:
0.5≦ε≦1350
with
$$ɛ = \frac{{P}_{P} \cdot \sqrt{{P}_{m}} \cdot f \cdot α \cdot \sqrt{t} \cdot \sqrt{κ}}{{d}^{2} \cdot \sqrt{v} \cdot \sqrt{{c}_{P}}} \cdot {10}^{4} \qquad ( equation 1 )$$
wherein:
Pₚ: pulse peak power of the exiting laser radiation (kW)
Pₘ: average power of the exiting laser radiation (W)
f: repetition rate of the laser pulses (kHz)
α: absorption of the laser radiation of the irradiated material (%) under normal conditions
t: pulse length of the laser pulses (ns), wherein t≧0.1 ns
κ: specific thermal conductivity (W/mK) under normal conditions and averaged over the various dimensions in space
d: diameter of the laser beam on the workpiece (μm)
v: scanning rate on the workpiece surface (mm/s)
cₚ: specific thermal capacity (J/kgK) under normal conditions,
carrying out the scanning in an atmosphere which is a vacuum, a gas or a gas mixture that is inert in relation to the surface under the process conditions.

11. The method according to claim 10, wherein
the pressure of the atmosphere is in a range from approx. 10⁻¹⁷ bar to approx. 5 bar, and
the temperature of the inert gas outside of the laser beam is in a range from approx. −50° C. to approx. 100° C.

12. The method according to claim 10, wherein 0.6≦ε≦approx. 1300.

13. The method according to claim 12, wherein approx. 0.7≦ε≦approx. 1250.

14. The method according to claim 10, wherein the pulse length of the radiation t is from approx. 0.1 ns to approx. 900 ns.

15. The method according to claim 14, wherein the pulse length of the radiation t is from approx. 0.1 ns to approx. 600 ns.

16. The method according to claim 10, wherein the pulse peak power of the exiting radiation Pₚ is from approx. 1 kW to approx. 1300 kW.

17. The method according to claim 16, wherein the pulse peak power of the exiting radiation Pₚ is from approx. 3 kW to approx. 650 kW.

18. The method according to claim 10, wherein the average power of the exiting laser radiation Pₘ is from approx. 0.2 W to approx. 28,000 W.

19. The method according to claim 18, wherein the average power of the exiting laser radiation Pₘ is from approx. 1 W to approx. 8000 W.

20. The method according to claim 10, wherein the frequency of the radiation f is from approx. 1 kHz to approx. 3000 kHz.

21. The method according to claim 20, wherein the frequency of the radiation f is from approx. 5 kHz to approx. 950 kHz.

22. The method according to claim 10, wherein the scanning rate on the workpiece surface v is from approx. 30 mm/s to approx. 8000 mm/s.

23. The method according to claim 21, wherein the scanning rate on the workpiece surface v is from approx. 200 mm/s to approx. 7000 mm/s.

24. The method according to claim 10, wherein the diameter of the laser beam on the workpiece d is from approx. 20 μm to approx. 4500 μm.

25. The method according to claim 24, wherein the diameter of the laser beam on the workpiece d is from approx. 50 μm to approx. 3500 μm.
